(19) United States
(12) Patent Application Publication
(10) Pub. No.: US 2024/0170934 A1
(43) Pub. Date: May 23, 2024

(54) HOSE-EQUIPPED WIRING MEMBER

(71) Applicant: Sumitomo Wiring Systems, Ltd., Mie (JP)

(72) Inventors: Kenta ARAI, Mie (JP); Takuya KABA, Mie (JP); Daisuke EBATA, Mie (JP); Hirozumi OKANIWA, Mie (JP); Hitomi NAGASAWA, Mie (JP)

(73) Assignee: Sumitomo Wiring Systems, Ltd., Mie (JP)

(21) Appl. No.: 18/282,586

(22) PCT Filed: Mar. 30, 2022
(86) PCT No.: PCT/JP2022/015768

§ 371 Date: Sep. 18, 2023

(30) Foreign Application Priority Data
Mar. 31, 2021 (JP) 2021-060156

(51) Int. Cl. H02G 3/04

(52) U.S. Cl. CPC H02G 3/04

(57) ABSTRACT

A hose-equipped wiring member includes: a wire-like transmission member; a sheet extending along a wiring route of the wire-like transmission member and including a holding surface to which the wire-like transmission member is fixed; and a hose fixed to the holding surface of the sheet.

### TECHNICAL FIELD

The present disclosure relates to a hose-equipped wiring member.

### BACKGROUND ART

Patent Document 1 discloses a technique of arranging a tube along a wire harness body while suppressing crush of the tube. In Patent Document 1, a tubular protection member is disposed in a state of covering the tube in a corrugate tube covering the wire harness body.

### PRIOR ART DOCUMENTS

### Patent Document(s)

Patent Document 1: Japanese Patent Application Laid-Open No. 2013-239419

### SUMMARY

### Problem to be Solved by the Invention

It is desired that a hose and a wiring member are integrally formed with a simple configuration without crushing a flow path of the hose as much as possible.

Accordingly, an object is to provide a technique capable of integrally forming a hose and a wiring member with a simple configuration without crushing a flow path of the hose as much as possible.

### Means to Solve the Problem

A hose-equipped wiring member according to the present disclosure includes: at least one wire-like transmission member, a sheet extending along a wiring route of the wire-like transmission member and including a holding surface to which the wire-like transmission member is fixed; and a hose fixed to the holding surface of the sheet.

### Effects of the Invention

According to the present disclosure, a hose and a wiring member can be integrally formed with a simple configuration without crushing a flow path of the hose as much as possible.

### BRIEF DESCRIPTION OF DRAWINGS

FIG. 1 is a perspective view illustrating a hose-equipped wiring member according to an embodiment 1.

FIG. 2 is a plan view illustrating a hose-equipped wiring member according to the embodiment 1.

FIG. 3 is a cross-sectional view along a III-Ill line in FIG. 2.

FIG. 4 is an explanation diagram illustrating manufacture of the hose-equipped wiring member according to the embodiment 1.

FIG. 5 is a plan view illustrating a first modification example of the hose-equipped wiring member.

FIG. 6 is a plan view illustrating a second modification example of the hose-equipped wiring member.

### DESCRIPTION OF EMBODIMENT(S)

### Description of Embodiment of Present Disclosure

Embodiments of the present disclosure are listed and described firstly.

A hose-equipped wiring member according to the present disclosure is as follows.
(1) A hose-equipped wiring member includes: at least one wire-like transmission member, a sheet extending along a wiring route of the wire-like transmission member and including a holding surface to which the wire-like transmission member is fixed; and a hose fixed to the holding surface of the sheet. Each of the wire-like transmission member and the hose is fixed to the sheet, thereby being integrally formed. Accordingly, the wire-like transmission member and the hose hardly interfere with each other, and the hose and the wiring member can be integrally formed with a simple configuration without crushing a flow path of the hose as much as possible.
(2) in the hose-equipped wiring member according to (2), the sheet and the hose may be fixed by a contact area direct fixation. Accordingly, the sheet and the hose can be simply fixed without intervention of the other member.
(3) In the hose-equipped wiring member according to (2), the sheet and the wire-like transmission member may be fixed by a contact area direct fixation. Accordingly, the sheet and the wire-like transmission member can be integrally formed by a fixing state similar to the sheet and the hose.
(4) In the hose-equipped wiring member according to any one of (1) to (3), it is also applicable that the hose is disposed on one outer edge of the sheet and the plurality of wire-like transmission members are disposed on another outer edge of the sheet. Accordingly, intersect of the wire-like transmission member and the hose is suppressed.
(5) In the hose-equipped wiring member according to (4), some of the plurality of wire-like transmission members may be branched in the another outer edge. Accordingly, intersect of the wire-like transmission member and the hose is suppressed also in a branch part.
(6) In the hose-equipped wiring member according to (4) or (5), the sheet may be provided with a bending route part bended so that the one outer edge is located on an outer peripheral side of the another outer edge. Accordingly, the hose can be disposed on an outer peripheral side of the wire-like transmission member in the bending route part, thus reduction in a curvature radius of the hose is suppressed.
(7) In the hose-equipped wiring member according to any one of (1) to (3), the wire-like transmission member and the hose may intersect with each other on the sheet. Even in a case where the wire-like transmission member and the hose intersect with each other on the sheet, the wire-like transmission member and the hose are fixed to the sheet while previously intersecting with each other, thus crush of the hose is suppressed.

### Detailed Description of Embodiment of Present Disclosure

Specific examples of a hose-equipped wiring member according to the present disclosure are described hereinafter with reference to the drawings. The present disclosure is not limited to these examples, but is indicated by claims, and it is intended that meanings equivalent to claims and all modifications within a scope of claims are included.

### Embodiment 1

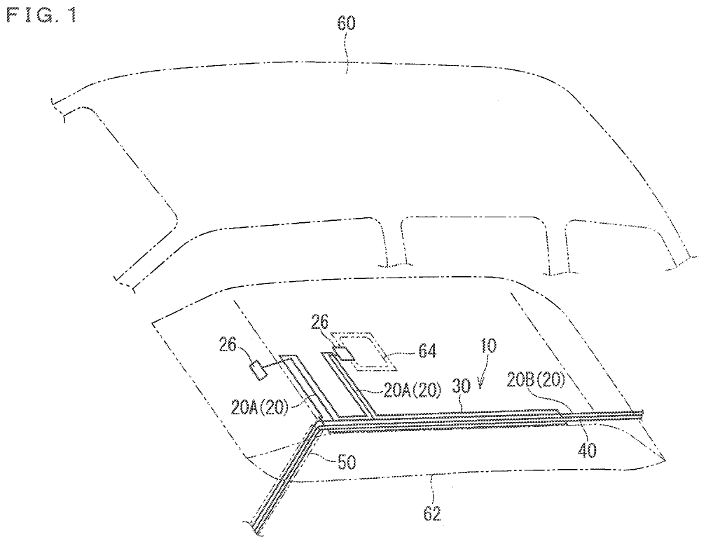

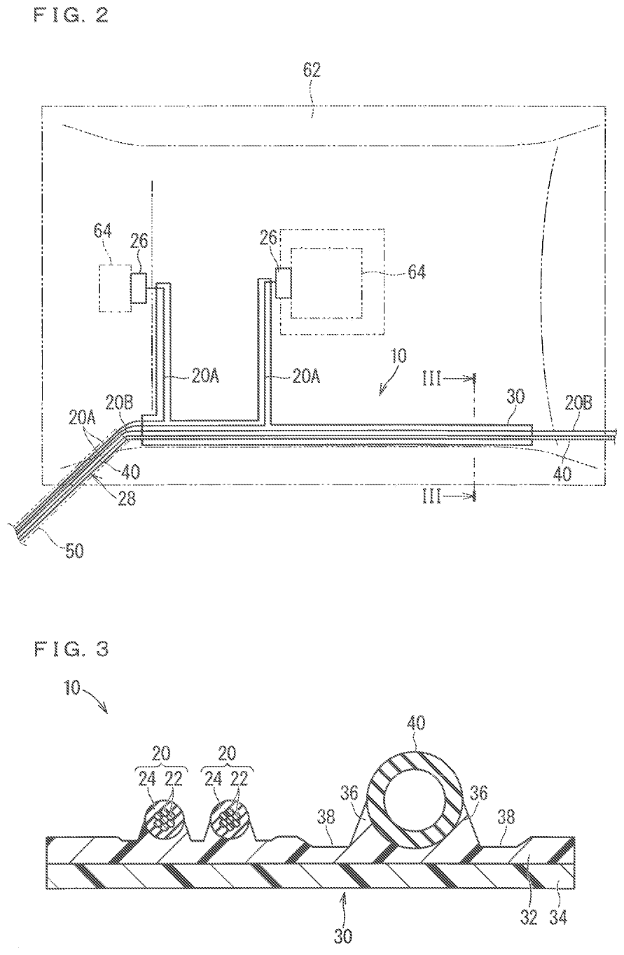

A hose-equipped wiring member according to an embodiment 1 is described hereinafter. FIG. 1 is a perspective view illustrating a hose-equipped wiring member 10 according to the embodiment 1. FIG. 2 is a plan view illustrating the hose-equipped wiring member 10 according to the embodiment 1. FIG. 3 is a cross-sectional view along a III-III line in FIG. 2.

The hose-equipped wiring member 10 includes a wire-like transmission member 20, a sheet 30, and a hose 40. The sheet 30 extends along a wiring route of the wire-like transmission member 20. The wire-like transmission member 20 is fixed to a holding surface of the sheet 30. The hose 40 is also fixed to the holding surface of the sheet 30. The hose 40 extends along the wire-like transmission member 20 in at least a part of a section. A part where the wire-like transmission members 20 and the hose 40 are parallelly arranged is fixed to the sheet 30. Accordingly, the wire-like transmission member 20 and the hose 40 are kept in a parallel state (integrated state) via the sheet 30.

In the description, the hose-equipped wiring member 10 according to the present example includes a part disposed in a space between a roof panel 60 and a roof liner 62 (space in a roof). The roof panel 60 and the roof liner 62 are located on an upper part of a vehicle interior to form a ceiling of a vehicle. The roof panel 60 is a member exposed to an outside of the vehicle to constitute an outer appearance of the vehicle. The roof liner 62 is a member exposed to an inside of the vehicle to constitute an inner appearance of the vehicle. The roof liner 62 is also referred to as a roof lining or a roof trim, for example, in some cases.

The wire-like transmission member 20 is a wire-like member transmitting electrical power or light, for example. The wire-like transmission member 20 is assumed to be a member connecting components in a vehicle. The wire-like transmission member 20 includes a transmission wire body 22 and a covering layer 24. The transmission wire body 22 is a transmission route transmitting electrical power or light. For example, when the wire-like transmission member 20 is an electrical wire, the transmission wire body 22 is a conductor core wire. The conductor core wire is made up of one or a plurality of strands. The strand is formed of copper, copper alloy, aluminum, or aluminum alloy as a material, for example. When the wire-like transmission member 20 is an optical fiber, the transmission wire body 22 is a core and a clad. The covering layer 24 is a layer covering the transmission wire body 22. A resin material constituting the covering layer 24 is not particularly limited, but can be appropriately set. For example, the wire-like transmission member 20 may be a general wire having a core wire and a covering layer around the core wire, or may also be a shield wire, a twisted wire, an enamel wire, a nichrome wire, or an optical fiber.

The wire-like transmission member 20 transmitting the electrical power may be various kinds of signal lines or various kinds of power lines. Some of the wire-like transmission members 20 transmitting the electrical power may be used as an antenna or coil, for example, transmitting or receiving a signal or electrical power to or from a space.

The wire-like transmission member 20 may be a single core wire. The single core wire is a single wire-like object. The single core wire is the wire-like transmission member with one transmission route. The wire-like transmission member 20 may be a multicore wire. The multicore wire is a compound body of a plurality of wire-like objects. The multicore wire is the wire-like transmission member with a plurality of transmission routes. The multicore wire may be a cable made up of collected twisted wires or a plurality of wire-like objects covered by a sheath, for example.

It is sufficient that the sheet 30 can fix the wire-like transmission member 20 and the hose 40, thus a material and a structure, for example, are not particularly limited. With regard to a material constituting the sheet 30, the sheet 30 is formed of a resin material herein. A material other than resin such as metal or an inorganic material, for example, may be used for the material constituting the sheet 30.

Described herein is an example that the sheet 30 has a double layer structure of a first layer 32 and a second layer 34. The structure of the sheet 30 may be a single layer structure, or a multilayer structure of three or more layers is also applicable. The first layer 32 is the fusion layer 32. The wire-like transmission member 20 and the hose 40 are fused and fixed to the fusion layer 32. The fusion layer 32 includes a resin material, or preferably includes a thermoplastic resin material. The resin material of the fusion layer 32 is softened and fused to a fusion target. A type of the resin material is not particularly limited, but polyvinyl chloride (PVC), polyethylene (PE), polypropylene (PP), or polyethylene terephthalate (PET) can be adopted, for example.

A structure of the fusion layer 32 is not particularly limited. For example, the fusion layer 32 may be a sheet having an evenly filled cross-sectional surface (also referred to as a non-foam sheet or a solid sheet, for example). The fusion layer 32 is also considered a foam sheet, for example. The fusion layer 32 is also considered a fibrous material sheet such s a braided cloth, a woven cloth, or a non-woven cloth, for example. One surface of the first layer 32 is one main surface of the sheet 30.

The second layer 34 is the additional layer 34. The additional layer 34 is formed of a material different from that of the fusion layer 32, or has a different structure. The additional layer 34 increases a function of the fusion layer 32, or adds a function which the fusion layer 32 does not have to the sheet 30. A material constituting the second layer 34 is a material described for the fusion layer 32 described above, metal, or an inorganic material, for example. A structure of the second layer 34 may be any of the structure described for the fusion layer 32 described above. One surface of the second layer 34 is the other main surface of the sheet 30.

The first layer 32 and the second layer 34 are fixed to each other while the other surface of the first layer 32 and the other surface of the second layer 34 have contact with each other. A fixing state of the first layer 32 and the second layer 34 is not particularly limited, however, fixing by fusion or adhesion is preferable. For example, when at least one of the first layer 32 and the second layer 34 is a sheet having voids in a surface such as a fibrous material sheet or a foam sheet, a resin material or an adhesive agent enters the voids and the layers can be fixed to each other. Such a configuration causes so-called anchor effect, thus the first layer 32 and the second layer 34 are rigidly fixed.

In the description herein, the first layer 32 is a solid sheet made of resin and the second layer 34 is a fibrous material sheet. In the description herein, the first layer 32 and the second layer 34 are fused to each other. That is to say, the resin of the first layer 32 enters between the fibers of the second layer 34 while having flowability, and is then hardened. Maintained accordingly is a state where the resin of the first layer 32 enters between the fibers of the second layer 34, and the first layer 32 and the second layer 34 are rigidly fixed to each other.

The first layer 32 and the second layer 34 may be formed to have the same size (the same planar shape). One of the first layer 32 and the second layer 34 may also be formed to be larger than the other one thereof. The first layer 32 and the second layer 34 are wholly fixed at a region where they have contact with each other. The first layer 32 and the second layer 34 may also be fixed only at a part of a region where they have contact with each other.

The sheet 30 may be a flexible member. For example, the first layer 32 is a solid sheet made up of flexible resin such as flexible PVC as a material, the second layer 34 is a non-woven cloth made up of PET as a material, and the sheet is a flexible member. For example, the sheet 30 may have a plastic property so as to be able to follow bending of the wire-like transmission member 20. It is also applicable that the wiring member can be bended in a thickness direction (bending so that a fold line follows the holding surface of the sheet 30).

Routes of the plurality of wire-like transmission members 20 are set in accordance with a position of a component to which the wire-like transmission members 20 are connected. The plurality of wire-like transmission members 20 are fixed to the sheet 30, thus the plurality of wire-like transmission members 20 are kept in a form following a wiring route corresponding to a position of a component as a connection destination of each wire-like transmission member 20. The route of the plurality of wire-like transmission members 20 may be made up of a combination of a straight route and a bending route. The sheet 30 may also be made up of a combination of a straight route and a bending route. The plurality of wire-like transmission members 20 may be fixed to the sheet 30 in a state where a branch wire is branched from a main wire. The sheet 30 may also be formed into a shape in which a part to which the branch wire is fixed is branched from a part to which the main wire is fixed. Herein, the plurality of wire-like transmission members 20 are bended on the sheet 30. The plurality of wire-like transmission members 20 are branched on the sheet 30.

The hose 40 includes a flow path through which a fluid can pass. The hose 40 can be bended. The hose 40 can be bended while keeping the flow path in a bending within a range in which flexion does not occur. The hose 40 may be made of elastomer having elasticity such as EPDM, for example. The hose 40 may be made up of resin such as flexible PVC as a material to have plasticity. In the present example, the fluid passing through the hose 40 is assumed to be a liquid. The fluid may be gas. In the present example, the liquid is assumed to be a washer liquid for a window. The liquid may be a liquid other than the washer liquid.

The hose 40 according to the present example is assumed to be the washer hose 40 connecting a storage part (washer tank) for the washer liquid and a washer nozzle. The washer tank and the washer nozzle are assumed to be disposed separately in a front-rear direction of a vehicle. For example, also applicable is a washer nozzle for a rear window in which the washer tank is disposed on a front side (closer to a front side than a vehicle interior) of the vehicle, and the washer nozzle is disposed on a rear side (closer to a rear side than the vehicle interior) of the vehicle. The washer tank may be disposed in a front room such as an engine room, for example. The washer nozzle may be disposed around the rear window together with a rear wiper, for example. The washer liquid reaches the washer nozzle from the washer tank via the washer hose 40. Then, the washer liquid is discharged from the washer nozzle toward the rear window.

The hose 40 is disposed to longitudinally pass through the vehicle in the front-rear direction. The hose 40 extends across a part of the vehicle interior in the front-rear direction through a space in the roof. More specifically, the hose 40 extends from the washer tank toward the space in the roof along an A pillar. The hose 40 longitudinally passes through the space in the roof to extends to the washer nozzle disposed closer to the rear side than the vehicle interior. A route of the hose 40 on the rear side of the vehicle is appropriately set in accordance with a vehicle type or a configuration whether or not the rear window is incorporated into a back door, for example. For example, the hose 40 may be disposed to come out of the space in the roof to a vehicle outside space as it is on the rear side of the vehicle, or may also be disposed to extend downward along a C pillar. One end portion or the other end portion of the hose 40 may be connected to a joint. The other hose connected to the joint may extend to the washer tank or the washer nozzle.

The wire-like transmission member 20 is also disposed in the space in the roof. The wire-like transmission member 20 may include a wire-like transmission member 20A for a roof apparatus 64 connected to an apparatus (roof apparatus 64) disposed in the roof, for example. A lamp or an antenna, for example, is applicable as the roof apparatus 64. The roof apparatus 64 is disposed in a predetermined position in the space in the roof. The wire-like transmission member 20A is branched from the hose 40 on the sheet 30 to extend to a position where the wire-like transmission member 20A is connected to the roof apparatus 64. The wire-like transmission member 20A may be connected to the roof apparatus 64 via a connector 26 provided on an end portion thereof, for example. The wire-like transmission member 20A is arranged in parallel to the hose 40 from a first end portion of the sheet 30 to the branch position.

The wire-like transmission member 20 may include a wire-like transmission member 20B for a rear side apparatus connected to an apparatus disposed on the rear side of the vehicle. A rear wiper apparatus may be applicable as the rear side apparatus. The wire-like transmission member 20B may be arranged in parallel to the hose 40 from the first end portion to a second end portion of the sheet 30. The wire-like transmission member 20B may extend to an outer side from the space in the roof together with the hose 40. The route of the hose 40 is a straight route from the first end portion to the second end portion of the sheet 30 herein.

Parts of the wire-like transmission members 20A and 20B extending along the A pillar may be bundled into a circular bundle-like shape by a banding member 50. The banding member 50 may be a tape or a banding band. Banding of a circular bundle part 28 is released near the first end portion of the sheet 30, and the wire-like transmission members are shifted to the arrangement on the sheet 30. A part of the circular bundle part 28 whose banding is released may be located on the sheet 30 or outside the sheet 30. The hose 40 may extend along the A pillar together with the circular bundle part 28. The hose 40 may be bundled together with the circular bundle part 28 by the banding member 50. The wire-like transmission members 20A and 20B and the hose 40 may not be bundled into the circular shape. The wire-like transmission members 20A and 20B and the hose 40 may extend along the A pillar while being fixed to the sheet 30.

The hose 40 is disposed on one outer edge of the sheet 30 and the plurality of wire-like transmission members 20 are disposed on the other outer edge of the sheet 30 on the holding surface of the sheet 30. Some of the plurality of wire-like transmission members 20 are branched in the other outer edge. The sheet 30 is also branched in accordance with the above configuration. In the present example, the hose 40 and the wire-like transmission member 20 do not intersect with each other on the sheet 30. In the present example, the hose 40 and the wire-like transmission member 20 are disposed away from each other on the sheet 30.

A thickness of the hose 40 is 2 millimeters to 8 millimeters, for example. The wire-like transmission member 20 fixed to the sheet 30 together with the hose 40 is a power line or a signal line for low voltage (for example, 12 V), and is normally thinner than the hose 40. The wire-like transmission member 20 fixed to the sheet 30 together with the hose 40 may include the wire-like transmission member 20 having a thickness equal to or larger than the hose 40.

Parts of the wire-like transmission members 20B extending to the rear side of the vehicle may be bundled into a circular bundle-like shape by a banding member. The banding member may be a tape or a banding band. Banding of a circular bundle part is released near the second end portion of the sheet 30, and the wire-like transmission members are shifted to the arrangement on the sheet 30. A part of the circular bundle part whose banding is released may be located on the sheet 30 or outside the sheet 30. The hose 40 may extend to the rear side of the vehicle together with the circular bundle part of the wire-like transmission member 20B. The hose 40 may be bundled together with the circular bundle part of the wire-like transmission member 20B by the banding member. The wire-like transmission member 20B and the hose 40 may not be bundled into the circular shape. The wire-like transmission member 20B and the hose 40 may extend to the rear side of the vehicle while being fixed to the sheet 30.

Applicable as the fixing state of the sheet 30 and the wire-like transmission member 20 are a contact area fixation and a non-contact area fixation, or both fixations may be used together. Also applicable as the fixing state of the sheet 30 and the hose 40 are a contact area fixation and a non-contact area fixation, or both fixations may be used together in the similar manner. The wire-like transmission member 20 and the hose 40 fixed to the sheet 30 are collectively referred to as the fixing targets 20 and 40 in some cases hereinafter. Herein, the contact area fixation indicates that a part where the sheet 30 and the fixing targets 20 and 40 have contact with each other is stuck and fixed. The non-contact area fixation is a fixing state which is not the contact area fixation, and indicates that a sewing thread, a cover, or an adhesive tape presses the fixing targets 20 and 40 toward the sheet 30 or sandwiches the sheet 30 and the fixing targets 20 and 40 to keep them in a fixing state.

Applicable as the configuration of the contact area fixation are a contact area indirect fixation and a contact area direct fixation, or both fixations may also be used together in different regions. Herein, the contact area indirect fixation indicates that the sheet 30 and the fixing targets 20 and 40 are indirectly stuck and fixed via an adhesive agent, a gluing agent, and a double-sided adhesive tape provided therebetween. The contact area direct fixation indicates that the sheet 30 and the fixing targets 20 and 40 are directly stuck and fixed without an intervention of the adhesive agent, for example, which is separately provided. Considered in the contact area direct fixation is that resin included in at least one of the sheet 30 and the fixing targets 20 and 40 is melted, thus the sheet 30 and the fixing targets 20 and 40 are stuck and fixed, for example.

In forming the state of such a contact area direct fixation, the resin is considered to be melted by heat or a solvent, for example. That is to say, the state of the contact area direct fixation may be the state of the contact area direct fixation by the heat or the state of the contact area direct fixation by the solvent. The contact area direct fixation by the heat is preferable.

At this time, a means of forming the state of the contact area direct fixation is not particularly limited, but a known means such as fusion can be used. For example, when the contact area direct fixation by heat is formed by fusion, adoptable are various types of fusion means such as ultrasonic fusion, heating pressurizing fusion, hot air fusion, and high-frequency fusion. When the state of the contact area direct fixation is formed by these means, the sheet 30 and the fixing targets 20 and 40 are in the state of the contact area direct fixation by these means. Specifically, when the state of the contact area direct fixation is formed by the ultrasonic fusion, for example, the sheet 30 and the fixing targets 20 and 40 are in the state of the contact area direct fixation by the ultrasonic fusion. Accordingly, the fusion fixation described above is one aspect of the contact area direct fixation.

Herein, the sheet 30 and the hose 40 are fixed by the contact area direct fixation. Both the sheet 30 and the wire-like transmission member 20 are fixed by the contact area direct fixation. In this case, outermost layers of the fixing targets 20 and 40 and the fusion layer 32 are fused to each other.

The outermost layer of the wire-like transmission member 20 is the covering layer 24. The covering layer 24 is made up of a material which can be fused to the fusion layer 32. A resin material constituting the covering layer 24 and a resin material constituting the fusion layer 32 may be the same type of material. A resin material constituting the fusion layer 32 and a resin material constituting the covering layer 24 are PVC or polyolefin, for example.

In the hose 40, the hose 40 itself is the outermost layer of the hose 40. The hose 40 is made up of a material which can be fused to the fusion layer 32. When the hose 40 is made up of EPDM as described above, it is also applicable that the resin material of the fusion layer 32 is mainly melted to be bonded to an outer surface of the hose 40. When the hose 40 is made up of PVC, for example, as described above, the resin material of the hose 40 may also be melted in addition to the resin material of the fusion layer 32 to be bonded to each other. When the resin material of the hose 40 and the resin material of the fusion layer 32 are the same type of resin material, melted materials in the resin material of the fusion layer 32 and the resin material of the hose 40 may be combined with each other.

The plurality of fixing parts (fusion parts) where the sheet 30 and the wire-like transmission member 20 are fixed (fused) may be provided at intervals along an extension direction of the wire-like transmission member 20. In the similar manner, the plurality of fixing parts (fusion parts) where the sheet 30 and the hose 40 are fixed (fused) may be provided at intervals along an extension direction of the hose 40. The interval between these fixing parts is not particularly limited, but can be appropriately set. The interval between the fixing parts where the sheet 30 and the wire-like transmission member 20 are fixed and the interval between the fixing parts where the sheet 30 and the hose 40 are fixed may the same or different from each other. For example, when the wire-like transmission member 20 includes a single-core signal line, the single-core signal line is bended more easily than the hose 40 by reason that the single-core signal line is relatively a thin line. In this case, the interval between the fixing parts where the sheet 30 and the single-core signal line are fixed may be smaller than the interval between the fixing parts where the sheet 30 and the hose 40 are fixed in a straight section in which the single-core signal line and the hose 40 are parallelly arranged. However, the fixing parts where the sheet 30 and the wire-like transmission member 20 are fixed may be continuously provided along the extension direction of the wire-like transmission member 20. In the similar manner, the fixing parts where the sheet 30 and the hose 40 are fixed may be continuously provided along the extension direction of the hose 40.

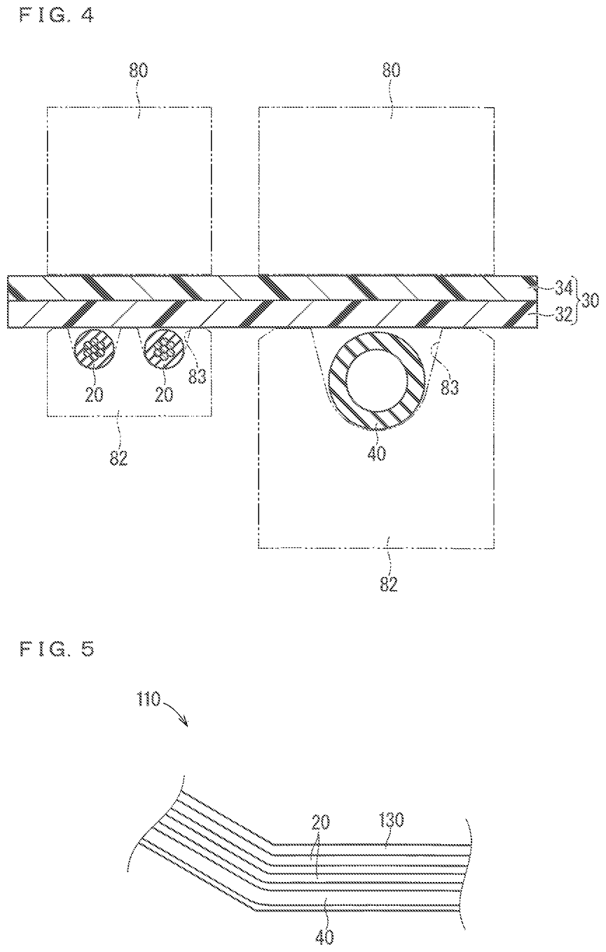

FIG. 4 is an explanation diagram illustrating manufacture of the hose-equipped wiring member 10 according to the embodiment 1.

In the example illustrated in FIG. 4, the hose 40 and the sheet 30 are fused by an ultrasonic fusion apparatus. The ultrasonic fusion apparatus includes a horn 80 and an anvil 82. The horn 80 provides ultrasonic vibration to a part to be fused. Accordingly, heat is generated in the part to be fused, and the part can be softened. The horn 80 can locally provide ultrasonic vibration to the part to be fused. Accordingly, heat generation in a part which is not to be fused can be suppressed. The anvil 82 sandwiches two members to be fused together with the horn 80. Normally, heat is generated mainly in a part to be fused by being sandwiched and pressed by the horn 80 and the anvil 82.

For example, the hose 40 is housed in a groove 83 formed in the anvil 82. Accordingly, strong pressing of the hose 40 by the horn 80 and the anvil 82 is suppressed. A depth of the groove 83 is equal to or larger than a diameter of the hose 40. Ultrasonic vibration is provided from the horn 80 to the sheet 30 while the sheet 30 is sandwiched and pressed between the horn 80 and a top part of a sidewall of the groove 83. Softening is started from a part of the sheet 30 on a lateral side of the hose 40. Then, the softened part fills a gap between an inner surface of the groove 83 and the hose 40 and reaches the hose 40 to be bonded to the hose 40. Accordingly, the sheet 30 and the hose 40 can be fixed without crushing the flow path of the hose 40 as much as possible.

The holding surface of the sheet 30 before fusion is a flat surface. The holding surface of the sheet 30 after fusion may have a concave-convex shape. As illustrated in FIG. 3, a convex part 36 and a concave part 38 may occur around the hose 40 in the sheet 30. The convex part 36 and the concave part 38 are concave-convex parts along the thickness direction of the sheet 30. The convex part 36 is provided in a part where the hose 40 and the sheet 30 are overlapped with each other. The convex part 36 is a part where holding surface is raised to fill a gap between the flat holding surface before fusion and the hose 40. For example, the convex part 36 is formed by the material of the softened sheet 30 entering the groove 83. The concave part 38 is provided on a lateral side of the convex part 36. The concave part 38 is a part in which the holding surface is concaved by supplying a material from the other part of the holding surface toward the convex part 36 to raise the holding surface and provide the convex part 36. The concave part 38 can also be considered a trace made by pressing the holding surface by the top part of the sidewall of the groove 83. There may be a case where the convex part 36 and the concave part 38 are not provided depending on a fusion condition (an output of the horn 80, a shape of the anvil 82, and a degree of force by pressing, for example).

The wire-like transmission member 20 and the sheet 30 may also be fused to by using an ultrasonic fusion apparatus. The groove 83 may be formed also in the anvil 82 used to fuse the wire-like transmission member 20 and the sheet 30. Ultrasonic fusion may be performed while the wire-like transmission member 20 in a state of being housed in the groove 83 and the sheet 30 are pressed by the horn 80 and the anvil 82. The groove 83 formed in the anvil 82 may have a size corresponding to a diameter of the wire-like transmission member 20. The convex part 36 and the concave part 38 may also be provided to the fusion part where the wire-like transmission member 20 and the sheet 30 are fused.

<Effect Etc.>

According to the hose-equipped wiring member 10 having the above configuration, each of the wire-like transmission member 20 and the hose 40 is fixed to the sheet 30, thereby being integrally formed. Accordingly, the wire-like transmission member 20 and the hose 40 hardly interfere with each other, and the hose 40 and the wiring member can be integrally formed with a simple configuration without crushing the flow path of the hose 40 as much as possible.

Herein, the sheet 30 and the hose 40 are fixed by the contact area direct fixation. Accordingly, the sheet 30 and the hose 40 can be simply fixed without intervention of the other member. The sheet 30 and the wire-like transmission member 20 are fixed to each other by the contact area direct fixation. Accordingly, the sheet 30 and the wire-like transmission member 20 can be integrally formed by a fixing state similar to the sheet 30 and the hose 40.

The hose 40 is disposed on one outer edge of the sheet 30 and the plurality of wire-like transmission members 20 are disposed on the other outer edge of the sheet 30. Accordingly, intersect of the wire-like transmission member 20 and the hose 40 is suppressed.

Some of the plurality of wire-like transmission members 20 are branched in the other outer edge. Accordingly, intersect of the wire-like transmission member 20 and the hose 40 is suppressed also in the branch part.

### Modification Example

FIG. 5 is a plan view illustrating a first modification example of the hose-equipped wiring member 10.

A hose-equipped wiring member 110 according to the first modification example is different from the hose-equipped wiring member 10 described above in that a bending route part is provided to a sheet 130. In the bending route part, the sheet 130 is bended so that one outer edge where the hose 40 is disposed is located on an outer peripheral side of the other outer edge where the plurality of wire-like transmission members 20 are disposed. Accordingly, the hose 40 can be disposed on the outer peripheral side of the wire-like transmission member 20, thus reduction in a curvature radius of the hose 40 is suppressed. Accordingly, the hose 40 is hardly flexed.

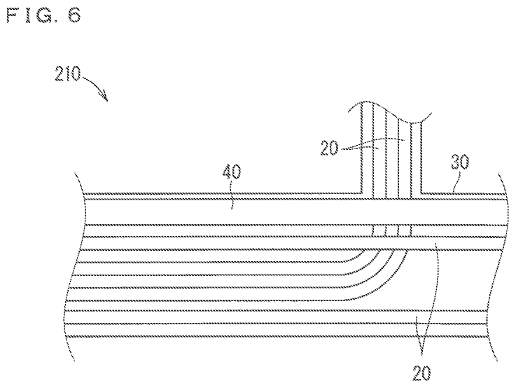

FIG. 6 is a plan view illustrating a second modification example of the hose-equipped wiring member 10.

A hose-equipped wiring member 210 according to the second modification example is different from the hose-equipped wiring members 10 and 110 described above in that the hose 40 and the wire-like transmission member 20 intersect with each other on the sheet 30. Even in a case where the wire-like transmission member 20 and the hose 40 intersect with each other on the sheet 30 as with the hose-equipped wiring member 210 according to the present example, the wire-like transmission member 20 and the hose 40 are fixed to the sheet 30 while previously intersecting with each other, thus crush of the hose 40 is suppressed.

The wire-like transmission member 20 in the wire-like transmission member 20 and the hose 40 may be located below (a side of the sheet 30) the hose 40 in the part where the wire-like transmission member 20 and the hose 40 intersect with each other. When the wire-like transmission member 20 is located below the hose 40, suppressed is increase of a length of the route of the wire-like transmission member 20 in passing across the hose 40. The hose 40 in the wire-like transmission member 20 and the hose 40 may be located below the wire-like transmission member 20 in the part where the wire-like transmission member 20 and the hose 40 intersect with each other. When the hose 40 is located below the wire-like transmission member 20, the wire-like transmission member 20 can press the hose 40 toward the sheet 30.

The wire-like transmission members 20 may intersect with each other on the sheet 30 as illustrated in FIG. 6. The wire-like transmission members 20 may not intersect with each other on the sheet 30.

In the above description, the hose 40 is disposed on one outer edge of the sheet 30 and the plurality of wire-like transmission members 20 are disposed on the other outer edge of the sheet 30, however, this configuration is not necessary. The hose 40 may be disposed in an intermediate part of the sheet 30 along the width direction. The wire-like transmission members 20 may be disposed on both sides of the hose 40. The wire-like transmission members 20A may be disposed on both sides of the hose 40. In this case, the wire-like transmission member 20A on at least one side intersects with the hose 40 on the sheet 30. It is also applicable that the wire-like transmission member 20A is disposed on one lateral side of the hose 40 and the wire-like transmission member 20B is disposed on the other lateral side of the hose 40. In this case, there may also be a case where the hose 40 does not intersect with the wire-like transmission members 20A and 20B on the sheet 30.

Described in the above description is the example that the hose-equipped wiring member 10 is disposed in the space in the roof, however, this configuration is not necessary. The hose-equipped wiring member 10 may be disposed in a space different from the space in the roof. For example, the hose-equipped wiring member 10 may be disposed in a space between a floor panel and a carpet.

The configurations described in the embodiments and modification examples thereof can be appropriately combined as long as they are not contradictory.

### EXPLANATION OF REFERENCE SIGNS

10, 110, 210 hose-equipped wiring member
20, 20A, 20B wire-like transmission member
22 transmission wire body
24 covering layer
26 connector
28 circular bundle part
30, 130 sheet
32 first layer
34 second layer
36 convex part
38 concave part
40 hose
50 banding member
60 roof panel
62 roof liner
64 roof apparatus
80 horn
82 anvil

1. A hose-equipped wiring member, comprising:
at least one wire-like transmission member;
a sheet extending along a wiring route of the wire-like transmission member and including a holding surface to which the wire-like transmission member is fixed; and
a hose fixed to the holding surface of the sheet.

2. The hose-equipped wiring member according to claim 1, wherein
the sheet and the hose are fixed by a contact area direct fixation.

3. The hose-equipped wiring member according to claim 2, wherein
the sheet and the wire-like transmission member are fixed by a contact area direct fixation.

4. The hose-equipped wiring member according to claim 1, wherein
the hose is disposed on one outer edge of the sheet and the plurality of wire-like transmission members are disposed on another outer edge of the sheet.

5. The hose-equipped wiring member according to claim 4, wherein
some of the plurality of wire-like transmission members are branched in the another outer edge.

6. The hose-equipped wiring member according to claim 4, wherein
the sheet is provided with a bending route part bended so that the one outer edge is located on an outer peripheral side of the another outer edge.

7. The hose-equipped wiring member according to claim 1, wherein
the wire-like transmission member and the hose intersect with each other on the sheet.
